(19) United States
(12) Patent Application Publication
(10) Pub. No.: US 2014/0203031 A1
(43) Pub. Date: Jul. 24, 2014

(54) Device for Paint Container

(71) Applicant: TRURIM, INC., Brentwood, CA (US)

(72) Inventor: Gary L. Eldridge, Brentwood, CA (US)

(21) Appl. No.: 14/159,347

(22) Filed: Jan. 20, 2014

Related U.S. Application Data
(60) Provisional application No. 61/754,474, filed on Jan. 18, 2013.
(60) Provisional application No. 61/757,165, filed on Jan. 27, 2013.
(60) Provisional application No. 61/770,693, filed on Feb. 28, 2013.
(60) Provisional application No. 61/775,690, filed on Mar. 11, 2013.

(51) Int. Cl. B44D 3/12

(52) U.S. Cl. CPC B44D 3/123
USPC 220/700

(57) ABSTRACT

A device for use with a paint can or other container, the device being adapted for use as a brush holder and/or a wiper bar for removing excess paint from a brush. In an embodiment the device can selectively press-fit-engage the rim of a selected container and a bar member can extend at least partially across the opening of the selected container.

### CLAIM OF PRIORITY

The present application claims the benefit of prior-filed provisional patent application No. 61/754,474, filed Jan. 18, 2013, prior-filed provisional patent application No. 61/757,165, filed Jan. 27, 2013, prior-filed provisional patent application No. 61/770,693, filed Feb. 28, 2013 and prior-filed provisional patent application No. 61/775,690, filed Mar. 11, 2013, the complete contents of each of which is hereby incorporated herein by reference.

### BACKGROUND

1. Field of the Invention

The present disclosure relates to the field of painting, specifically a device for use with a paint can or container that can be used as a brush rest and/or a wiper bar to remove excess paint.

2. Background

Painting is both a hobby and profession to many people throughout the world. Buildings, furniture, walls—they are all popular mediums for applying the seemingly endless variety of paints and varnishes available these days. But a common issue faced when undertaking a painting project is the sheer mess it can produce, especially when it comes to the paint can itself. Traditionally, as a painter is engaged in a project, they dip a brush into a can of paint and wipe the brush on the edge of the can to remove excess paint and prevent dripping of paint as the brush is moved to the painting surface. The wiping process causes quite a mess both on the outside of the container as well as in-between the inner and outer edges of the container's top rim, resulting in not only a visual mess, but an obstructed paint can rim which can then cause an improper lid seal or lid removal problems as a result of dried paint causing undesirable adhesion of the lid to the rim. Moreover, when a painting break is warranted, the painter usually rests the brush on the rim or edges of the paint can or on another surface, resulting in paint dripping into the can rim, over the rim edge and down the outside of the paint can, or paint soiling another surface. Attempts to solve these problems have resulted in devices that are cumbersome and/or time-consuming to mount, have complicated attachment or usage mechanisms, are bulky and high profile apparatuses, and/or are difficult to clean.

What is needed is a device that can mount on the edge of a paint can at a single location, with a bar member that can extend across a portion of a paint can opening. The device should be easy to mount and dismount, while providing a wiper bar and/or brush rest. In some embodiments, the device can have a cantilever-type structure, and can also be used as a paint can opener, magnetized holder, and/or can have an attachment mechanism for storing the device with a paint can when not in use.

### BRIEF DESCRIPTION OF THE DRAWINGS

FIG. 1A depicts a side view of another embodiment of the current device.

FIG. 1B depicts a side view of one embodiment of the current device.

FIG. 2A depicts a view of an alternate embodiment of the current device.

FIG. 2B depicts a perspective view of the embodiment of the current device shown in FIG. 2A.

FIG. 3 depicts a perspective view of the embodiment of the current device shown in FIG. 1A.

FIG. 4 depicts a side view of one embodiment of the current device having an angled bar member, and showing a reference line A-A.

FIG. 5A depicts a side view of an alternate embodiment of the current device with a reference line A-A.

FIG. 5B depicts a side view of another embodiment of the current device having a hooked end.

FIG. 6 depicts a side view of one embodiment of the current device with a cross-sectional view of the wall and edges of a paint can.

FIG. 7 depicts a bottom view of one embodiment of the current device.

FIG. 8 depicts a top view of one embodiment of the current device with a reference line A-A.

FIG. 9 depicts a front view of one embodiment of the current device with a reference line A-A.

FIG. 10 depicts a front view of an alternate embodiment of the current device.

FIG. 11 depicts one embodiment of the current device in use on a paint can, with a paintbrush resting on a bar member.

FIG. 12 depicts another embodiment of the current device in use on a paint can, with a bar member being used to wipe excess paint from a paintbrush.

FIG. 13 depicts a top view of yet another embodiment of the current device in use on a paint can, with an offset bar member allowing for unobstructed paint access.

FIG. 14A depicts one embodiment of the current device being applied to a paint can.

FIG. 14B depicts the embodiment shown in FIG. 14A after mounting of the device has been completed and it is fully engaged with a paint can and ready for use.

FIG. 14C depicts one embodiment of the current device being removed from a paint can.

### DETAILED DESCRIPTION

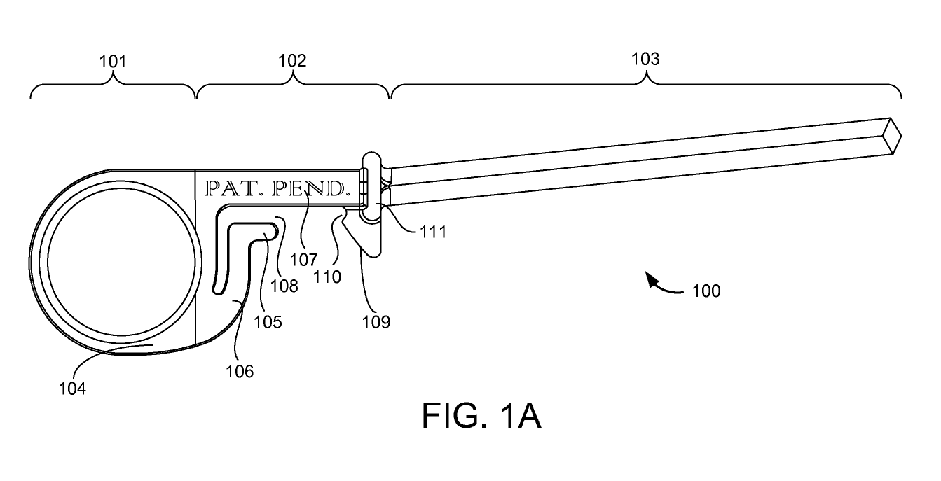

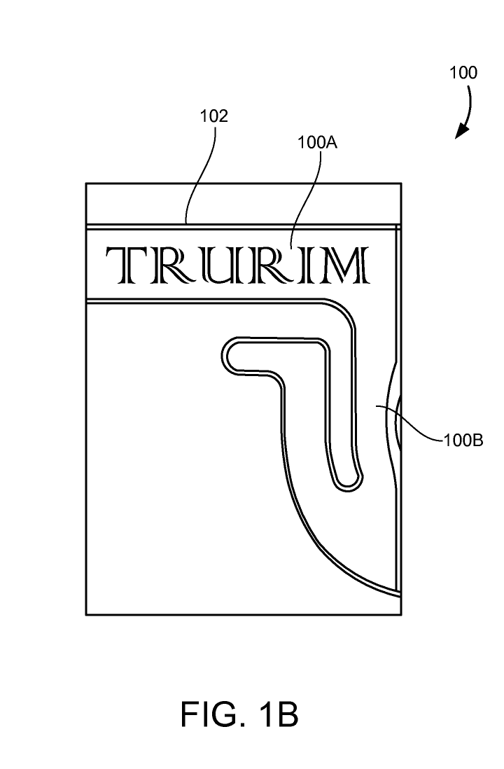

Referring to FIG. 1B, in some embodiments a device 100 can comprise a mounting member and/or anchoring component 102. A mounting member 102 can comprise a support mechanism 100A coupled with an anchoring mechanism 100B. As depicted, a support mechanism 100A can be an elongated member a substantially horizontal orientation while an anchoring mechanism 100B can be an elongated member in a substantially vertical orientation. A support mechanism 100A can be adapted to rest on the rim or protruding rim of a paint can and/or selected container, while an anchoring mechanism 100B can anchor a device 100 to the outer surface of a paint can. In some embodiments, an anchoring mechanism 100B can comprise an arm member as shown, but in other embodiments an anchoring mechanism 100B can be comprised of a magnet. In yet other embodiments, an anchoring mechanism 100B can be comprised of reusable adhesive, putty, or any other known and/or desired material or method for selectively attachment of a device 100 to a paint can.

A support mechanism 100A can be adapted for use as a paintbrush rest or holder while a device 100 is in use. Moreover, in some embodiments a support mechanism 100A can be adapted for use as a wiper for removing excess paint from a paintbrush. A support mechanism 100A can comprise a magnet, hook and loop material, putty, reusable adhesive, non-skid material, or any other desired material or mechanism to assist in temporarily holding a paintbrush in place. A support mechanism 100A and/or an anchoring mechanism 100B can be comprised of plastic, polymer, wood, metal, silicone, and/or any other known and/or convenient material or combination of materials. The material or materials that comprise a support mechanism 100A and/or an anchoring mechanism 100B can be rigid in some embodiments, but can have elastomeric qualities in other embodiments. In further embodiments, a support mechanism 100A and/or an anchoring mechanism 100B can be at least partially comprised of non-slip material, either as a coating, layer, or as a property inherent to its base material.

In some embodiments, and as shown in FIG. 1A, a device 100 can comprise a handle member 101, a mounting member 102, and/or a bar member 103. A device 100 can be a cantilever-type apparatus, whereby a bar member and/or support component 103 extends beyond both a handle member 101 and a mounting member 102, and a mounting member 102 can act as the single point of support across the device 100. A device 100 can also be adapted for use with paint cans or other containers of various sizes, including gallon and quart-sized containers.

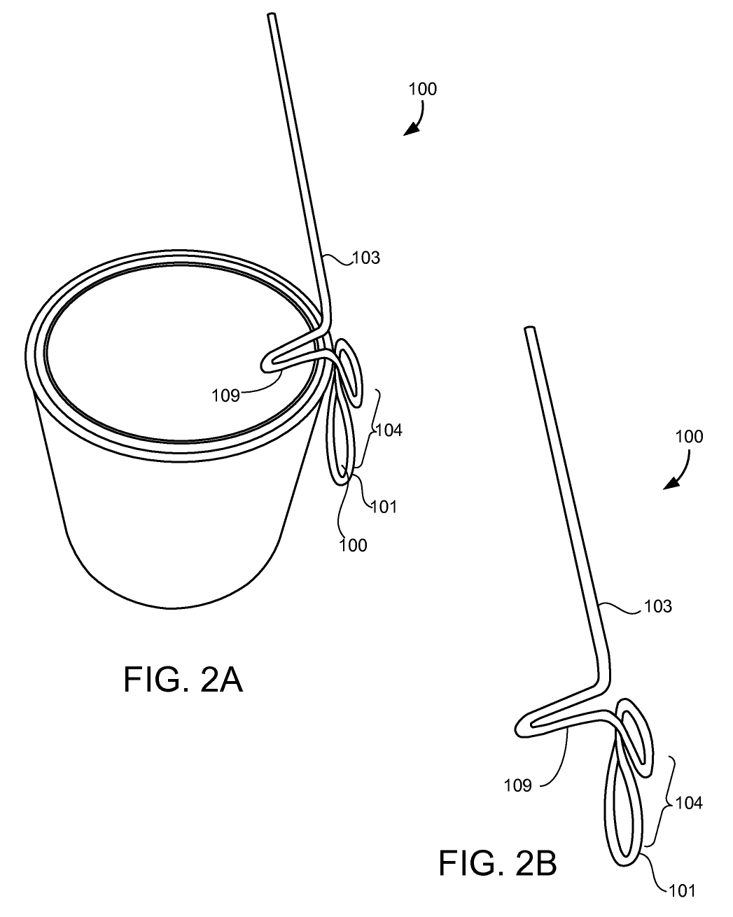

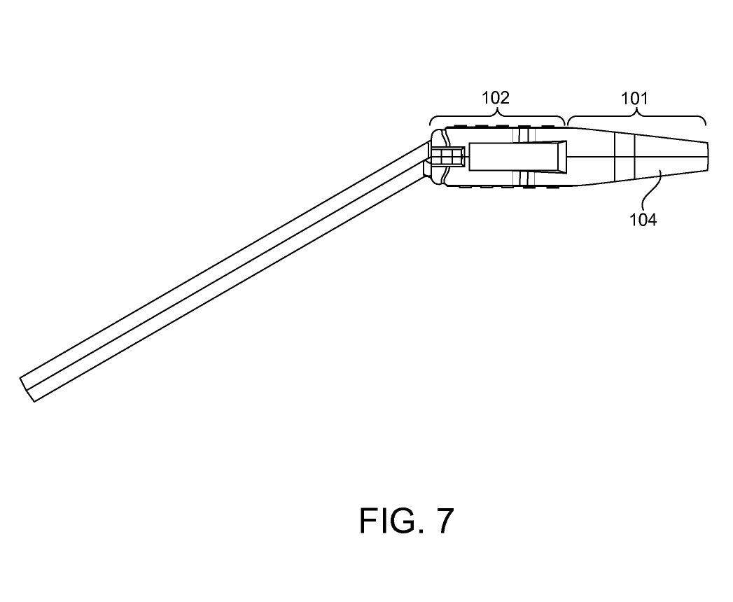

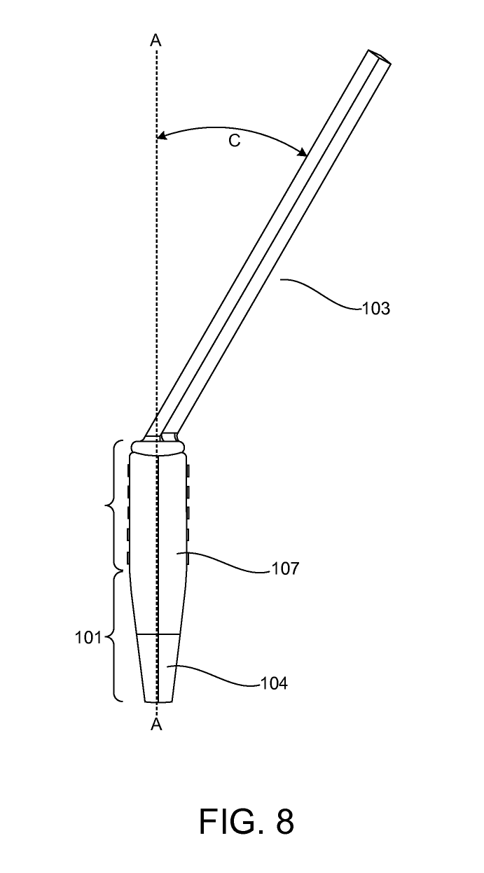

A handle member 101 can have a proximal end and distal end. In some embodiments, a handle member 101 can have at least one loop member 104 adapted to accept a human finger. As shown in FIG. 1A, a loop member 104 can have a substantially vertical orientation and can have a substantially circular planar cross-sectional geometry. A loop member 104 can have any desired thickness and/or can have any known and/or convenient diameter and/or size. In some embodiments, as depicted in the underside and topside views in FIGS. 7-8, respectively, in some embodiments the thickness of a loop member 104 can vary between the proximal and distal ends. As depicted in FIGS. 2A and 2B, in other embodiments a handle member 101 can have a plurality of loop members 104, each adapted to accept a human finger, and at least one loop member 104 can have a substantially horizontal orientation. Furthermore, in some embodiments, at least one loop member 104 can have a hexagonal, square, octagonal, triangular, ellipsoidal, and/or asymmetrical planar cross-sectional geometry. In yet other embodiments, at least one loop member 104 can be either a partially open loop or a completely closed loop. In additional embodiments, a handle member 101 can have any other known and/or convenient mechanism or part member for gripping or handling a device 100. In yet further embodiments, a device 100 may be devoid of a handle member 101.

A handle member 101 and/or loop member 104 can be comprised of plastic, polymer, wood, metal, silicone, and/or any other known and/or convenient material or combination of materials. The material or materials that comprise a handle member 101 and/or loop member 104 can be rigid in some embodiments, but can have elastomeric qualities in other embodiments. In further embodiments, a handle member 101 can be at least partially comprised of non-slip material, either as a coating, layer, or as a property inherent to its base material. Such non-slip properties can assist a user in maintaining proper grip on a device 100 during use, thereby preventing unintentional movement of a device 100. In some embodiments, a handle member 101 can have anti-bacterial, anti-fungal, and/or anti-mold coating, material, and/or properties. At least a portion of the surface of a handle member 101 and/or at least one loop member 104 can be smooth, or can have ridges, bumps, raised portions, grooves, indentations, or any other known and/or convenient surface characteristic and/or combination of characteristics. Moreover, in some embodiments at least a portion of a handle member 101 and/or at least one loop member 104 can be magnetic, such that a paintbrush or any other desired magnetic device can be selectively held in place for storage or other purposes.

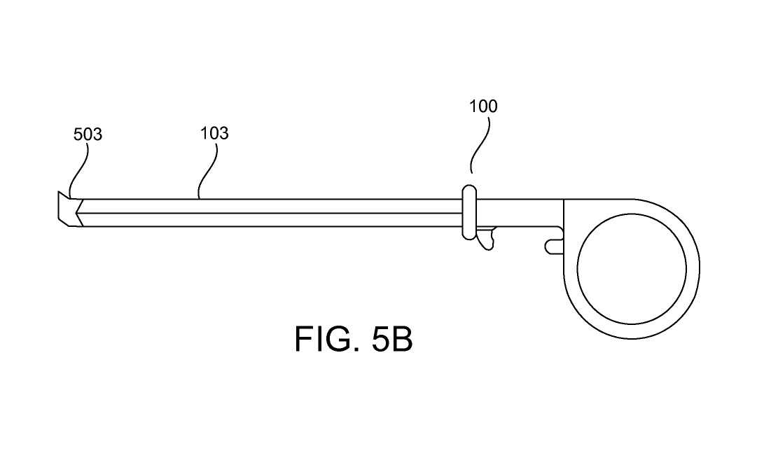

As depicted in FIG. 5A, in alternate embodiments a handle member 101 and/or at least one loop member 104 can further comprise at least one can opener extension member 501 and/or at least one can opener segment 502. A can opener extension member 501 can be a rigid piece of material (metal, plastic, and/or any other desired material) that can extend from any portion of a handle member 101 and/or at least one loop member 104, and can be adapted to fit under a paint can lid lip and pry it open from a closed can position. At least one can opener extension member 501 can extend in the same plane as at least one loop member 104 and/or handle member 101, as shown in FIG. 5A, or in other embodiments a can opener extension member 501 can be oriented orthogonal to the plane of at least one loop member 104 and/or handle member 101. In other embodiments, a loop member 104 and/or a handle member 101 can comprise at least one can opener segment 502, whereby a portion of the loop member 104 and/or handle member 101 material is relatively thin and/or rigid such that it can be used to pry open a paint can lid. In alternate embodiments, a loop member 104 can be a partially open loop wherein at least one of the open loop ends can be adapted for use as a paint can opener. In yet further embodiments, a loop member 104 and/or a handle member 101 can be adapted for use as a mallet-type instrument for securing a paint can lid to a paint can.

Referring back to FIG. 1A, a device 100 can further comprise a mounting member 102 having a proximal end and a distal end. The proximal end of a mounting member 102 can be coupled with the distal end of a handle member 101 via adhesive, epoxy, heat bonding, screws, bracket plates, chemical bonding, and/or any other known and/or convenient method of coupling. In other embodiments, a mounting member 102 and handle member 101 can simply be portions of one continuous piece of material fabricated via injection molding or any other known and/or convenient fabrication process.

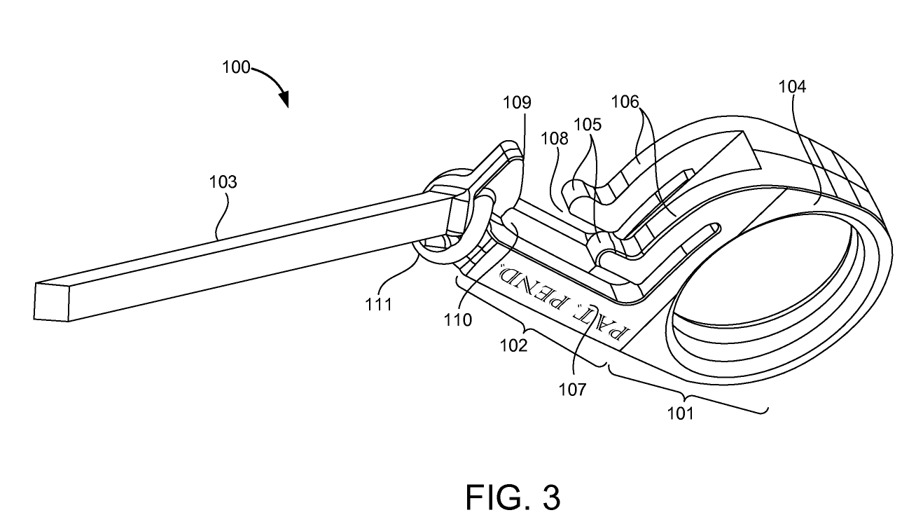

Referring to FIG. 1A, a mounting member 102 can comprise at least one external lip member and/or protrusion 105 and/or at least one internal lip member and/or interior engagement element 109. In some embodiments, at least one external lip member 105 can extend from the proximal end of the mounting member 102 toward the distal end of the mounting member 102. In additional embodiments, at least one external lip member 105 can extend from a mounting member 102 via at least one arm member and/or support arm 106. At least one arm member 106 can extend from the lower portion of the proximal end of a mounting member 102, curving upwards, as shown in FIG. 1A, or can extend from any other point on a mounting member 102 and in any other spatial fashion. As depicted in the perspective view of one embodiment of the device 100 in FIG. 3, in some embodiments a mounting member and/or anchoring component 102 can comprise two arm members and/or support arms 106 (first and second support arms 106), each culminating in an external lip member and/or protrusion 105 (first and second protrusions 105). In yet other embodiments and as shown in FIG. 5A, an external lip member 105 can extend without the presence of an arm member 106 and/or can be coupled directly to the distal end of a handle member 101. In some embodiments, an exterior element can comprise a handle member 101, a loop member 104, an external lip member 105 and at least one arm member 106. In alternate embodiments, an exterior element can comprise a handle member 101, an external lip member 105 and at least one arm member 106. In still further alternate embodiments an exterior element can comprise a handle member 101 and an external lip member 105.

At least one external lip member 105 and/or at least one arm member 106 can be comprised of plastic, polymer, wood, metal, silicone, and/or any other known and/or convenient material or combination of materials. The material or materials that comprise at least one external lip member 105 and/or at least one arm member 106 can be rigid in some embodiments, but can have elastomeric qualities in other embodiments. As described in detail below, at least one external lip member 105 and/or at least one arm member 106 can be comprised of at least partially elastomeric material to facilitate installation of a device 100. In alternate embodiments, an external lip member 105 can be rigid.

In further embodiments, at least one external lip member 105 and/or at least one arm member 106 can be at least partially comprised of non-slip material, either as a coating, layer, or as a property inherent to its base material. Such non-slip properties can enable proper positioning of a device 100 during use and can prevent unintentional movement of a device 100. In some embodiments, at least one external lip member 105 and/or at least one arm member 106 can have anti-bacterial, anti-fungal, and/or anti-mold coating, material, and/or properties. At least a portion of the surface of an external lip member 105 and/or an arm member 106 can be smooth, or can have ridges, bumps, raised portions, grooves, indentations, or any other known and/or convenient surface characteristic and/or combination of characteristics. In yet further a mounting member 102 can comprise a magnet (not shown) proximate to its distal end, wherein the magnet can be adapted to couple with the metal portion of a paintbrush. In such an embodiment, a user can selectively couple a paintbrush with the magnet such that the paintbrush is oriented vertically with its bristles pointing downward into a paint can, thereby providing a convenient resting place for the paintbrush and allowing any excess paint to drip down into the paint can rather than on the paint can rim, paint can outer surface, or on another surface.

In some embodiments, at least one external lip member 105 can be coupled with at least one arm member 106 and/or the proximal end of a mounting member 102 via adhesive, epoxy, heat bonding, screws, bracket plates, chemical bonding, and/or any other known and/or convenient method of coupling. In other embodiments, a mounting member 102, at least one external lip member 105, and/or at least one arm member 106 can simply be portions of one continuous piece of material fabricated via injection molding or any other known and/or convenient fabrication process.

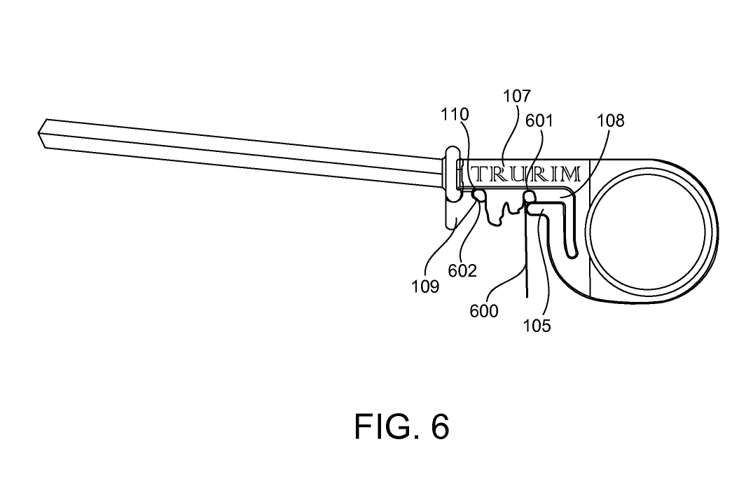

Referring back to FIG. 1A, a mounting member 102 can further comprise at least one support mechanism and/or traversing element 107. In the embodiment depicted, a support mechanism 107 protrudes from the upper portion of the proximal end of a mounting member 102 and extends towards the distal end of a mounting member 102 in a substantially horizontal fashion. In other embodiments, a support mechanism 107 can be angled above or below the horizontal plane or oriented in any other known and/or convenient manner. In some embodiments, at least one support mechanism 107 can be linear and can have a substantially rectangular orthogonal cross section. As depicted in FIGS. 1A and 3-5B, at least one external lip member 105 can be oriented below at least one support mechanism 107 such that a gap 108 exists between them. As shown in FIG. 6, a gap 108 can be adapted to accept or fit over the outer edge 601 of a paint can 600. In some embodiments, the vertical distance between at least one external lip member 105 and at least one support mechanism 107 (i.e., gap 108) can be slightly less than the height of the outer edge 601 of a paint can 600 such that the outer edge 601 can be selectively engaged in a pressure-mounted fashion.

At least one support mechanism 107 can have a lateral cross-section of any known and/or desired geometry and/or size. In some embodiments, and as depicted in FIG. 3, a support mechanism 107 can have a substantially U-shaped lateral cross-section of substantially consistent size across the length of the support mechanism 107. In other embodiments, a support mechanism 107 can have a circular, rectangular, or loop lateral cross-section, or any other known and/or convenient cross-section geometry. In yet other embodiments, at least one support mechanism 107 can have varying width and/or height at various points along its length.

At least one support mechanism 107 can be comprised of plastic, polymer, wood, metal, silicone, and/or any other known and/or convenient material or combination of materials. The material or materials that comprise at least one support mechanism 107 can be rigid in some embodiments, but can have elastomeric qualities in other embodiments. At least one support mechanism 107 can be comprised of at least partially elastomeric material to enable a device 100 to be properly pressure-mounted when in use. In further embodiments, at least one support mechanism 107 can be at least partially comprised of non-slip material, either as a coating, layer, or as a property inherent to its base material. Such non-slip properties can enable proper positioning of a device 100 during use and can prevent unintentional movement of a device 100. In some embodiments, at least one support mechanism 107 can have anti-bacterial, anti-fungal, and/or anti-mold coating, material, and/or properties. At least a portion of the surface of a support mechanism 107 can be smooth, or can have ridges, bumps, raised portions, grooves, indentations, or any other known and/or convenient surface characteristic and/or combination of characteristics. Moreover, in some embodiments at least a portion of a support mechanism 107 can be magnetic, such that a paintbrush or any other desired magnetic device can be selectively held in place.

In some embodiments, at least one support mechanism 107 can be coupled with the proximal and/or distal ends of a mounting member 102 via adhesive, epoxy, heat bonding, screws, bracket plates, chemical bonding, and/or any other known and/or convenient method of coupling. In other embodiments, a mounting member 102 and support mechanism 107 can simply be portions of one continuous piece of material. In yet further embodiments, a support mechanism 107 can represent the distal end of a mounting member 102.

Referring back to FIG. 1A, a mounting member 102 can further comprise at least one internal lip member 109 substantially proximate to its distal end. In the embodiment depicted, an internal lip member 109 extends downward from the distal end of a support mechanism 107 and has a substantially triangular planar cross-section. In other embodiments, an internal lip member 109 can have any other known and/or convenient orientation and/or geometry. The proximal end and/or proximal side of an internal lip member 109 can further comprise a groove 110. As shown in FIG. 6, a groove 110 can be adapted to accept or fit over at least a portion of the inner edge 602 of a paint can 600. Further, the proximal side of an internal lip member 109 can be angled to aid in installation of the device 100 on a paint can, such that an internal lip member 109 surface can slide over an inner edge 602 with user-applied force as described in use and operation descriptions provided herein and as would be readily apparent to those having ordinary skill in the art. Furthermore, the horizontal distance between an external lip member 105 and a groove 110 can be slightly less than the width or thickness of a paint can rim, such that outer and inner edges 601 602 can be engaged in a pressure-mounted fashion when in use.

At least one internal lip member 109 can be coupled with the distal end of a mounting member 102 and/or at least one support mechanism 107 via adhesive, epoxy, heat bonding, screws, bracket plates, chemical bonding, and/or any other known and/or convenient method of coupling. In other embodiments, an internal lip member 109, a mounting member 102, and/or at least one support mechanism 107 can simply be portions of one continuous piece of material fabricated via injection molding or any other known and/or convenient fabrication process.

At least one internal lip member 109 can be comprised of plastic, polymer, wood, metal, silicone, and/or any other known and/or convenient material or combination of materials. The material or materials that comprise at least one internal lip member 109 can be rigid in some embodiments, but can have elastomeric qualities in other embodiments. At least one internal lip member 109 can be comprised of at least partially elastomeric material to enable a device 100 to be properly pressure-mounted when in use. In some embodiments, at least one internal lip member 109 can have anti-bacterial, anti-fungal, and/or anti-mold coating, material, and/or properties. At least a portion of the surface of an internal lip member 109 can be smooth, or can have ridges, bumps, raised portions, grooves, indentations, or any other known and/or convenient surface characteristic and/or combination of characteristics. Moreover, in some embodiments at least a portion of an internal lip member 109 can be magnetic, such that a paintbrush or any other desired magnetic device can be selectively held in place.

As shown in FIG. 1A, a device 100 can further comprise at least one bar member 103 having a proximal end and a distal end. The proximal end of at least one bar member 103 can be coupled with the distal end of a mounting member 102 via adhesive, epoxy, heat bonding, screws, bracket plates, chemical bonding, and/or any other known and/or convenient method of coupling. In other embodiments, a bar member 103 and a mounting member 102 can simply be portions of one continuous piece of material fabricated via injection molding or any other known and/or convenient fabrication process.

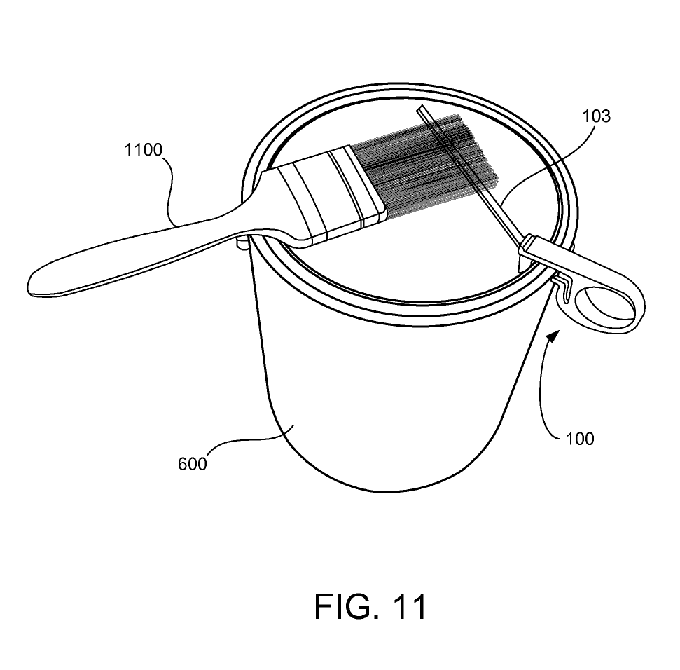

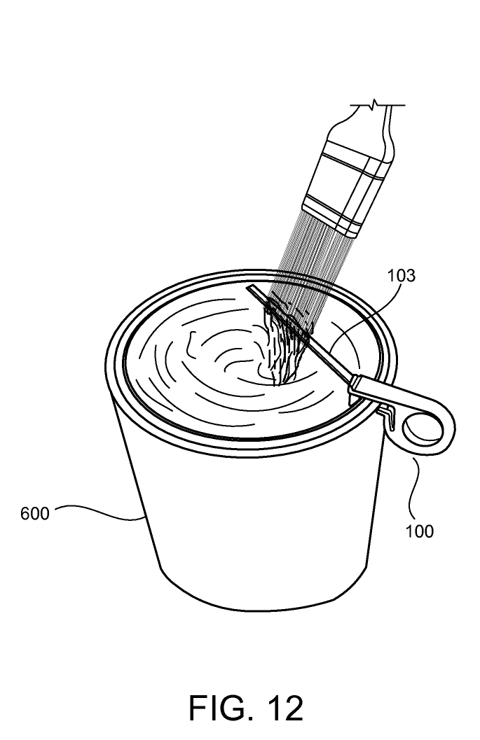

At least one bar member 103 can be utilized for any desired purpose when in use. In the embodiment depicted in FIG. 11, a bar member 103 can be used as a rest or holder for a brush 1100, thereby allowing any excess paint to drip into a paint can 600 when a brush 1100 is not in use. In other embodiments and as shown in FIG. 12, a bar member 103 can be used to cleanly wipe excess paint from a paintbrush 1100, allowing the paint to drip back into the paint can 600 rather than accumulating on the rim of a paint can 600 or spilling over the sides or outside of a paint can 600. In some embodiments, a bar member 103 can be a straight elongated member, but in other embodiments, a bar member 103 can be curved or can have any other desired geometry.

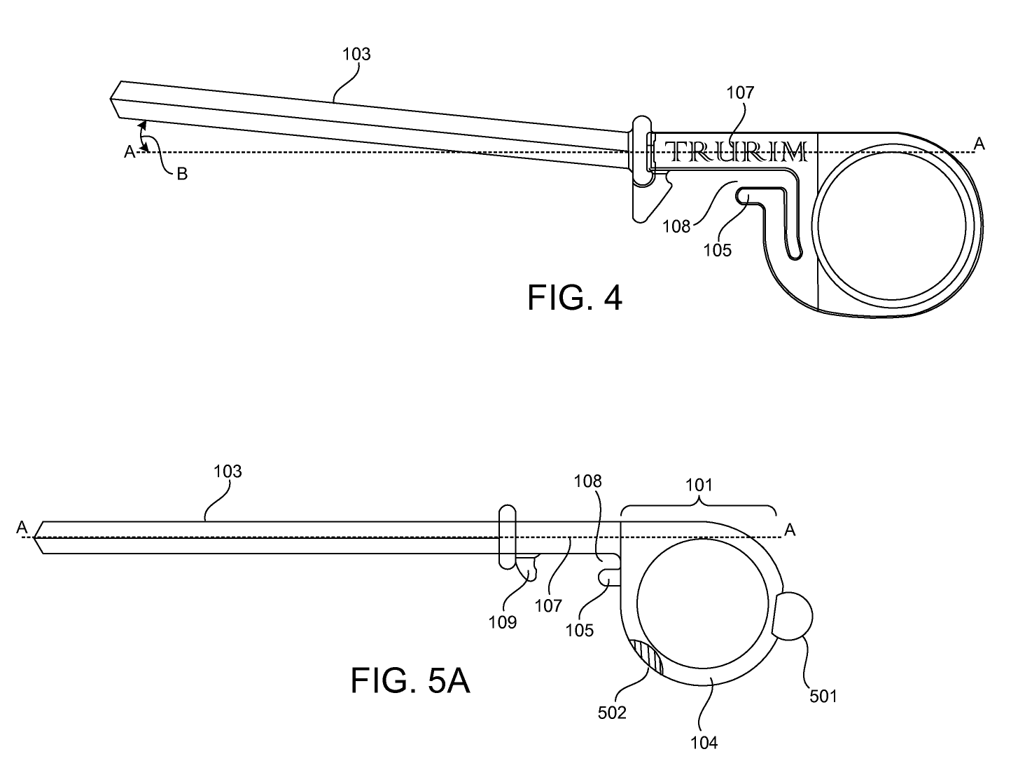

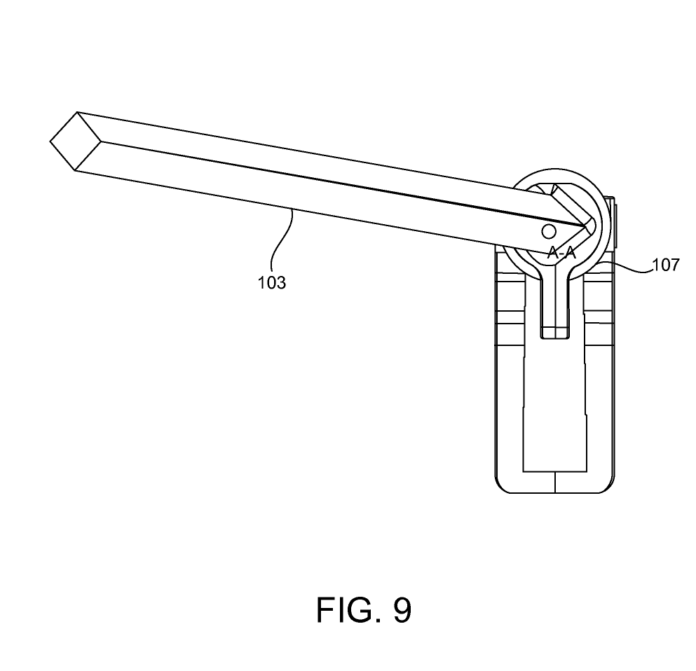

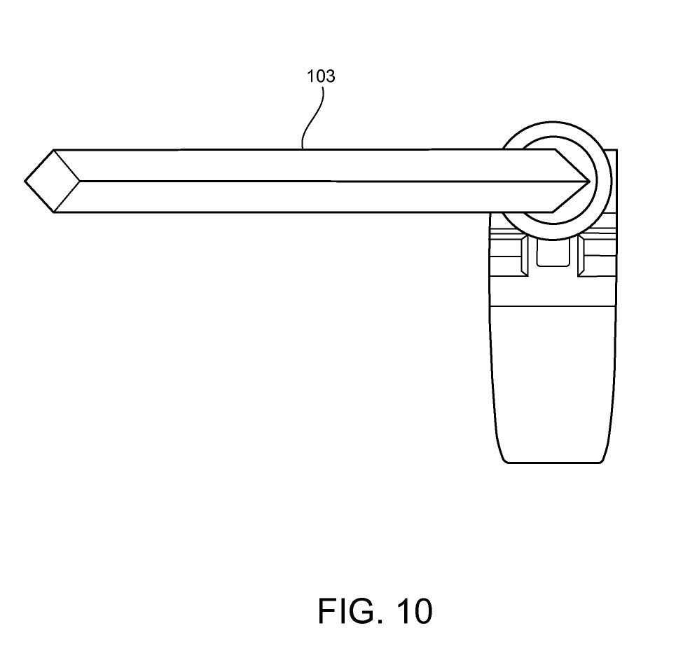

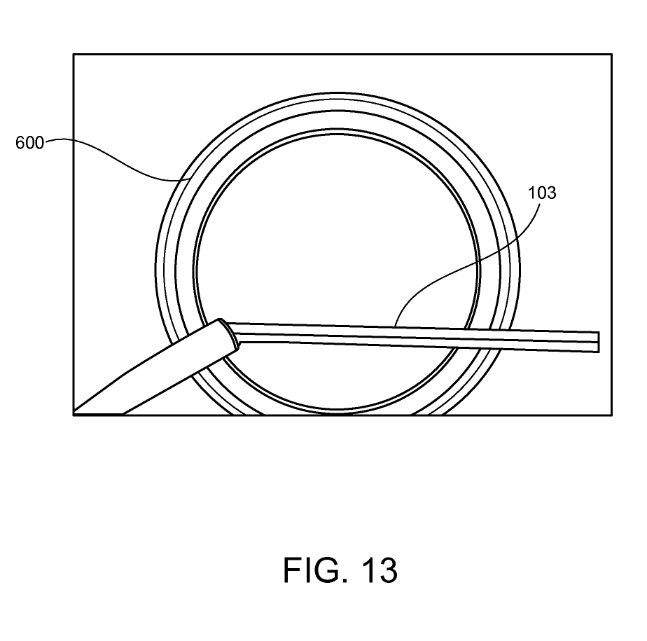

Referring to FIGS. 4, 5A, 8, and 9, line A-A is shown to represent an imaginary line passing longitudinally through the center of a support mechanism 107, and is used for reference purposes in the following description of the spatial orientation of a bar member 103. As shown in the side view of one embodiment of a device 100 in FIG. 4, a bar member 103 can originate proximate to the distal end of a mounting member 102 and extend upwards with respect to reference line A-A, resulting in an acute angle B between bar member 103 and reference line A-A. Furthermore, in the top view of the embodiment depicted in FIG. 8, a bar member 103 can extend away from reference line A-A, again resulting in an acute angle C between bar member 103 and reference line A-A. The front view of one embodiment of a device 100 depicted in FIG. 9 further illustrates the offset orientation of a bar member 103 with respect to a reference line A-A passing longitudinally through the center of a support mechanism 107. This type of configuration can be useful in preventing a bar member 103 from extending directly across the center of a paint can 600. Rather, as shown in FIGS. 11-13, an offset bar member 103 can allow for unobstructed access to the contents of a paint can 600 in use. In other embodiments, however, and as shown in FIGS. 5A, 5B and 10, a bar member 103 can be oriented in substantially the same horizontal plane as a support mechanism 107, and/or a support mechanism 107 and a bar member 103 can have the same linear orientation.

As depicted in FIGS. 1A and 4-8, in some embodiments at least one bar member 103 can have substantially greater length than that of a mounting member 102, such that the load of a bar member 103 can be carried to a mounting member 102 when in use. In other embodiments, a bar member 103 can have any other desired length relative to a mounting member 102 and/or a handle member 101. In the embodiment depicted in FIGS. 3 and 9, a bar member 103 has a square lateral cross-section. In other embodiments, a bar member 103 can have a circular, triangular, rectangular, or hexagonal lateral cross-section, or any other known and/or convenient cross-sectional geometry. Moreover, as shown in the embodiments depicted in FIGS. 1A and 3-9, a bar member 103 can have uniform depth and width along its length. In alternate embodiments, a bar member 103 can be tapered in a conical or other fashion, or can have any other known and/or convenient geometry.

A bar member 103 can be comprised of plastic, polymer, wood, metal, silicone, and/or any other known and/or convenient material or combination of materials. The material or materials that comprise a bar member 103 can be rigid in some embodiments, but can have elastomeric qualities in other embodiments. In some embodiments, a bar member 103 can have anti-bacterial, anti-fungal, and/or anti-mold coating, material, and/or properties. At least a portion of the surface of a bar member 103 can be smooth, or can have ridges, bumps, raised portions, grooves, indentations, or any other known and/or convenient surface characteristic and/or combination of characteristics. In some embodiments, the surface of a bar member 103 can be slick, such that paint can easily drip off or be wiped away. Moreover, in some embodiments at least a portion of a bar member 103 can be magnetic, such that a paintbrush or any other desired magnetic device can be selectively held in place. As shown in FIG. 5B, in some embodiments, the distal end of at least one bar member 103 can further comprise a hook, curved end, or other mechanism 503 adapted for use as a paint can opener, hanger for a paint brush handle, and/or to hang a device 100 on the rim of a paint can or otherwise be selectively attached to a paint can for convenient storage purposes.

Referring to FIGS. 1A and 3, a device 100 can further comprise a drip stop 111 coupled with the distal end of a mounting member 102 and/or the proximal end of at least one bar member 103. A drip stop 111 can act as a barrier between a bar member 103 and the rest of a device 100. A drip stop 111 can also be adapted to guide the flow of excess paint from a bar member 103 such that once it reaches a drip stop 111, the paint simply drains back into a paint can when in use. A drip stop 111 can also ensure that during removal of a device 100 from a paint can after use, at which time a device 100 may need to be tilted, paint does undesirably flow onto a mounting member 102 and/or handle member 101.

As depicted in FIG. 1A, in some embodiments a drip stop 111 can have a substantially toroidal geometry and a substantially vertical orientation. In the embodiment shown, a drip stop 111 can be coupled with the distal end of a support mechanism 107 and the proximal end of a bar member 103. In other embodiments, a drip stop 111 can have any other known and/or convenient geometry and/or configuration. A drip stop 111 can be coupled with a bar member 103, mounting member 102, internal lip member 109, and/or support mechanism 107 via adhesive, epoxy, heat bonding, screws, bracket plates, chemical bonding, and/or any other known and/or convenient method of coupling. In other embodiments, a drip stop 111, at least one bar member 103, a mounting member 102, an internal lip member 109, and/or at least one support mechanism 107 can simply be portions of one continuous piece of material fabricated via injection molding or any other known and/or convenient fabrication process.

A drip stop 111 can be comprised of plastic, polymer, wood, metal, silicone, and/or any other known and/or convenient material or combination of materials. The material or materials that comprise a drip stop 111 can be rigid in some embodiments, but can have elastomeric qualities in other embodiments. In some embodiments, a drip stop 111 can have anti-bacterial, anti-fungal, and/or anti-mold coating, material, and/or properties. At least a portion of the surface of a drip stop 111 can be smooth, or can have ridges, bumps, raised portions, grooves, indentations, or any other known and/or convenient surface characteristic and/or combination of characteristics. In some embodiments, the surface of a drip stop 111 can be slick, such that paint can easily drip off or be wiped away. Moreover, in some embodiments at least a portion of a drip stop 111 can be magnetic, such that a paintbrush or any other desired magnetic device can be selectively held in place.

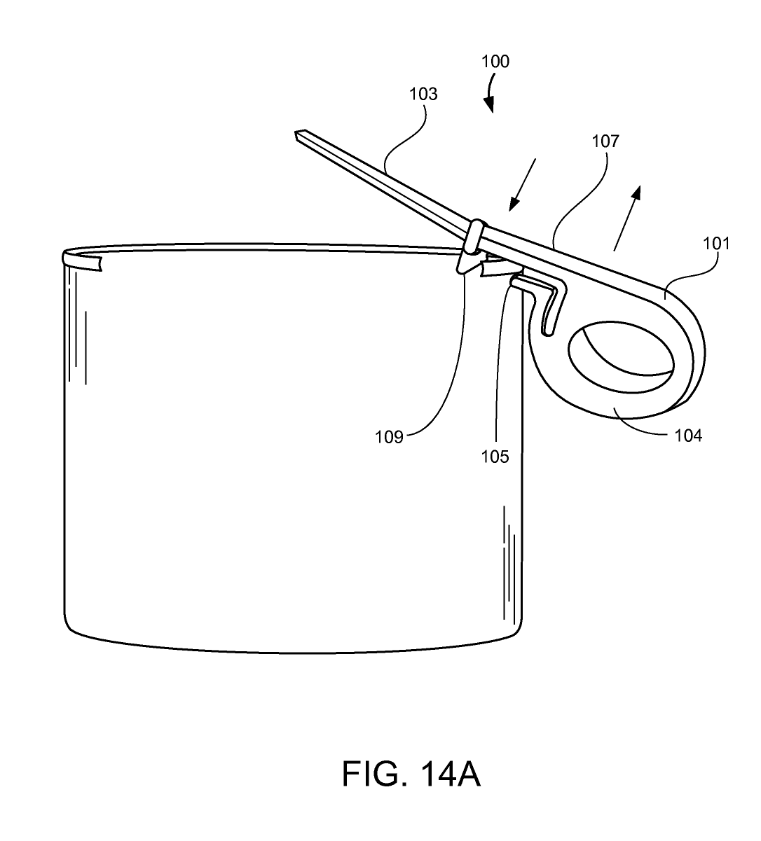

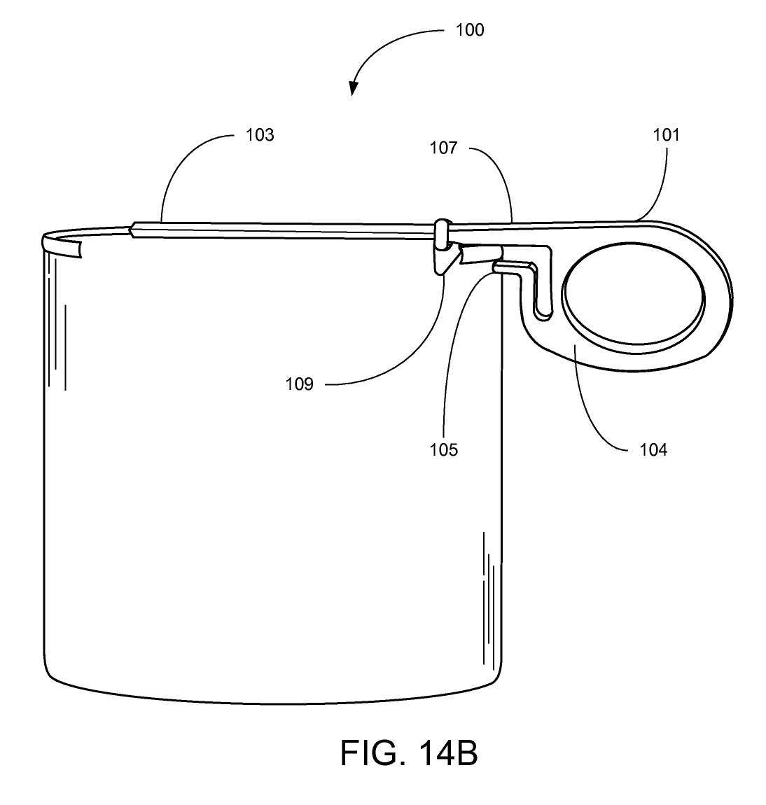

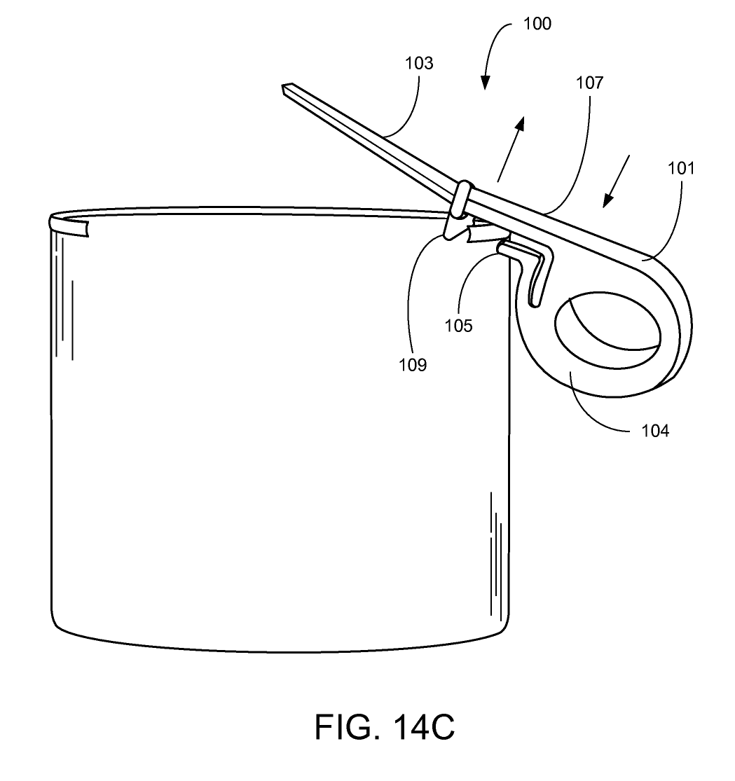

In use, some embodiments of a device 100 can be mounted to a paint can 600 in the following manner. Referring to FIG. 14A, a user can grip a handle member 101 via a loop member 104 and hold a device 100 at an angle such that a bar member 103 points in an upward direction. A user can then engage at least one external lip member 105 and at least one support mechanism 107 with the outer edge 601 of a paint can 600. By pushing down on a device 100 proximate to the distal end of a mounting member 102 (and in some embodiments using a drip stop 111 as leverage), the angled surface of an internal lip member 109 can slide over an inner edge 602, and an internal lip member 109 can be forced over inner edge 602, finally settling in a position where inner edge 602 rests in the groove 110 of the internal lip member 109. In some embodiments and as shown in FIGS. 4 & 6, an external lip member 105 and/or arm member 106 can have elastomeric properties, allowing it to temporarily deflect or deform while a rigid internal lip member 109 snaps into place over inner edge 602 of a paint can 600. In some embodiments, a fully engaged device 100 can be held in place by the pressure applied to the walls of a paint can 600 by external and internal lip members 105 109.

In an alternate embodiment and as shown in FIG. 5A, external and internal lip members 105 109 can be substantially rigid, such that during the installation process a paint can rim can deform in an accordion-like fashion during installation and/or removal of a device 100 due to the forces placed on the paint can rim by rigid external and internal lip members 105 109. Additionally, various components of the device 100 can have various rigidity and/or stiffness, as desired. In some embodiments, a support arm 106 can have a stiffness less than a stiffness of at least one of a protrusion 105, a traversing element 107 and/or an interior engagement element 109.

As depicted in FIG. 14B, with a mounting member 102 fully engaged with the outer and inner edges 601 602 of a protruding rim of a paint can 600 in a press-fit manner, a device 100 is ready to use in ways exemplified by, but not limited to, those shown in FIGS. 11 and 12. After use, a device 100 can be removed by gripping a handle member 101 as before, but this time applying force in a downward direction on a handle member 101 to disengage an internal lip member 109 from an inner edge 602 of a paint can 600. Once disengaged, an external lip member 109 can then easily slide off of the outer edge 601 of a paint can 600. In other embodiments, a device 100 can be removed by gripping a handle member 101 to release external lip member 105 first, followed by release of internal lip member 109.

In yet further embodiments, a mounting member 102 can be devoid of an external and/or internal lip member 105 109 and can instead have an anchoring mechanism 100B as shown in FIG. 1B. In such an embodiment, an anchoring mechanism 100B can be a magnet that can hold a device 100 in place on a paint can 600. In some instances, an anchoring mechanism 100B can be positioned on a paint can 600 such that a support mechanism 107 is held above the edges 601 602 of the paint can 600. In other embodiments, a device 100 can comprise a combination of magnets, lip members 105 109, and/or any other known and/or convenient anchoring components.

Although the method has been described in conjunction with specific embodiments thereof, it is evident that many alternatives, modifications and variations will be apparent to those skilled in the art. Accordingly, the method as described and hereinafter claimed is intended to embrace all such alternatives, modifications and variations that fall within the spirit and broad scope of the appended claims.

What is claimed is:

1. A support structure comprising:
an anchoring component; and
a support component coupled with said anchoring component;
wherein said anchoring component comprises:
an exterior element adapted to selectively engage at least one of the exterior body of a selected container and an protruding rim of said selected container, wherein said exterior element comprises a protrusion configured to selectively engage said selected container substantially proximate to the juncture of said protruding rim of said selected container and said exterior body of said selected container;
a traversing element coupled with said exterior element, configured to traverse said protruding rim of said selected container; and
an interior engagement element coupled with said traversing element, wherein said exterior element is coupled with an end of said traversing element and said interior engagement element is coupled with an opposing end of said traversing element.

2. The support structure of claim 1 wherein said exterior element further comprises:
a support arm located between said traversing element and said protrusion.

3. The support structure of claim 2 wherein said interior engagement element, said traversing element and said exterior element are configured to allow a selective press-fit engagement with said protruding rim of said selected container.

4. The support structure of claim 3 wherein said support component extends from said anchoring component.

5. The support structure of claim 4 wherein said support component is a bar member.

6. The support structure of claim 5 wherein said bar member is configured to extend at least partially across the interior opening of said selected container.

7. The support structure of claim 1 wherein said interior engagement element, said traversing element and said exterior element are configured to allow a selective press-fit engagement with said protruding rim of said selected container.

8. The support structure of claim 7 wherein said support component extends from said anchoring component.

9. The support structure of claim 8 wherein said support component is a bar member.

10. The support structure of claim 9 wherein said bar member is configured to extend at least partially across the interior opening of said selected container.

11. The support structure of claim 2 wherein said exterior element further comprises:
a second protrusion configured to selectively engage said selected container substantially proximate to the juncture of said protruding rim of said selected container and said exterior body of said selected container; and
a second support arm located between said traversing element and said second protrusion.

12. The support structure of claim 2 wherein a stiffness of said support arm is less than a stiffness of at least one of said protrusion, said traversing element and said interior engagement element.

13. The support structure of claim 1 wherein said exterior element further comprises a second protrusion configured to selectively engage said selected container substantially proximate to the juncture of said protruding rim of said selected container and said exterior body of said selected container, substantially adjacent to said protrusion.

14. A device for attachment to a selected container comprising:
an anchoring component comprising:
an exterior element adapted to selectively engage at least one of the exterior body of a selected container and a protruding rim of said selected container, wherein said exterior element comprises first and second protrusions configured to selectively engage said selected container substantially proximate to the juncture of said protruding rim of said selected container and said exterior body of said selected container;
a first support arm located between said traversing element and said first protrusion;
a second support arm located between said traversing element and said second protrusion;
a traversing element coupled with said exterior element, configured to traverse said protruding rim of said selected container; and
an interior engagement element coupled with said traversing element, wherein said exterior element is coupled with an end of said traversing element and said interior engagement element is coupled with an opposing end of said traversing element;
wherein said interior engagement element, said traversing element and said exterior element are configured to allow a selective press-fit engagement with said protruding rim of said selected container; and
a bar member extending from said anchoring component, said bar member configured to extend at least partially across the interior opening of said selected container.
